(19) United States
(12) Patent Application Publication
(10) Pub. No.: US 2024/0126660 A1
(43) Pub. Date: Apr. 18, 2024

(54) FILE-BASED ASYNCHRONOUS AND FAILSAFE EXECUTION IN CLOUD

(71) Applicant: SAP SE, Walldorf (DE)

(72) Inventor: Florian Geckeler, Berlin (DE)

(21) Appl. No.: 17/965,438

(22) Filed: Oct. 13, 2022

(51) Int. Cl. G06F 11/14; G06F 9/54

(52) U.S. Cl. CPC G06F 11/1464; G06F 9/542; G06F 2201/80

(57) ABSTRACT

Execution of an operation in a cloud environment is performed by a controller receiving an event from an eventing framework. The controller determines a number of phases of the cloud operation, and checks a status of each phase. Where a status of a phase of a cloud operation is open (e.g., having not been completed owing to interruption due to a communications failure in the cloud), the controller executes the phase of the cloud operation, records the completed status in a storage medium, and reports the status. Where a status of a phase of the cloud operation is determined to be complete, the controller iterates to the next phase. The controller may configure the eventing framework to receive the event. The eventing framework may be external to the controller (e.g., KUBERNETES). Alternatively, the eventing framework may be internal to the controller (for example communicating events based upon a polling mechanism).

### BACKGROUND

Unless otherwise indicated herein, the approaches described in this section are not prior art to the claims in this application and are not admitted to be prior art by inclusion in this section.

In cloud environments, recovery of database content at a particular point in time can be requested by a user. Data may be passed through multiple components until reaching one that is responsible for processing the request and executing the recovery.

Such passing of information can be error prone (e.g., when a connection is interrupted during the process of sending the information). This can undesirably lead to a state where the database is not fully recovered. Under such circumstances, manual intervention and interaction in the cloud environment may be needed in order to properly restore the database to showing its accurate status.

### SUMMARY

Execution of an operation in a cloud environment is performed by a controller receiving an event from an eventing framework. The controller determines a number of phases of the cloud operation, and checks a status of each phase. Where a status of a phase of a cloud operation is open (e.g., having not been completed owing to interruption due to a communications failure in the cloud), the controller executes the phase of the cloud operation, records the completed status in a storage medium, and reports the status. Where a status of a phase of the cloud operation is determined to be complete, the controller iterates to the next phase.

The controller may configure the eventing framework to receive the event. The eventing framework may be external to the controller (e.g., KUBERNETES). Alternatively, the eventing framework may be internal to the controller (for example communicating events based upon a polling mechanism).

The following detailed description and accompanying drawings provide a better understanding of the nature and advantages of various embodiments.

### BRIEF DESCRIPTION OF THE DRAWINGS

FIG. 1 shows a simplified diagram of a system according to an embodiment.

FIG. 2 shows a simplified flow diagram of a method according to an embodiment.

FIG. 3 shows an overview of an exemplary cloud system.

FIG. 4 show different phases in a recovery controller.

FIG. 5 shows an error occurring during a recovery operation.

FIG. 6 shows efficient execution by the recovery controller of only a remaining phase in order to complete an interrupted recovery operation.

FIG. 7 illustrates hardware of a special purpose computing machine configured to implement cloud execution according to an embodiment.

FIG. 8 illustrates an example computer system.

### DETAILED DESCRIPTION

Described herein are methods and apparatuses that implement execution in a cloud environment. In the following description, for purposes of explanation, numerous examples and specific details are set forth in order to provide a thorough understanding of embodiments according to the present invention. It will be evident, however, to one skilled in the art that embodiments as defined by the claims may include some or all of the features in these examples alone or in combination with other features described below, and may further include modifications and equivalents of the features and concepts described herein.

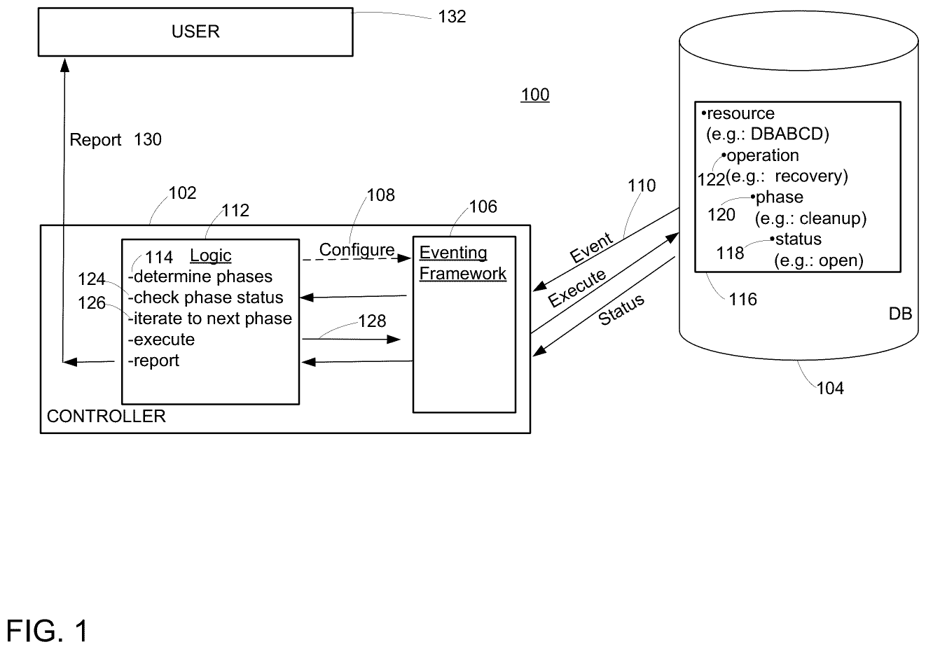

FIG. 1 shows a simplified view of an example system 100 that is configured to implement cloud operation according to an embodiment. Specifically, a controller 102 is in communication with a non-transitory computer readable storage medium 104 via an eventing framework 106.

In some embodiments, the eventing framework may be internal to the controller. In other embodiments, the eventing framework may be external to the controller (e.g., KUBERNETES).

In a preliminary stage, the controller may communicate a configuration 108 to the eventing framework. This configuration may specify the particular event that is to be communicated to the controller in order to trigger execution of an operation.

According to certain (e.g., internal eventing framework) embodiments, the configuration may specify parameters (e.g. frequency) of a polling action. According to other (e.g., external eventing framework) embodiments, the configuration may specify those events that are to be routed to the controller.

During a subsequent (cloud operation execution) stage, an event 110 is received. Based upon logic 112 of the controller, a number of phases of the event are determined 114 and recorded as a resource 116 in the storage medium.

Next, a status 118 of each phase 120 of the operation 122 is checked 124. If a status of a phase is completed, the controller iterates 126 to the next phase.

Otherwise, the controller executes 128 an as-yet unexecuted phase of the operation, updating the status only after execution of the operation phase is completed.

Lastly, the controller may report 130 to a user 132, the status of execution of a phase of the cloud operation.

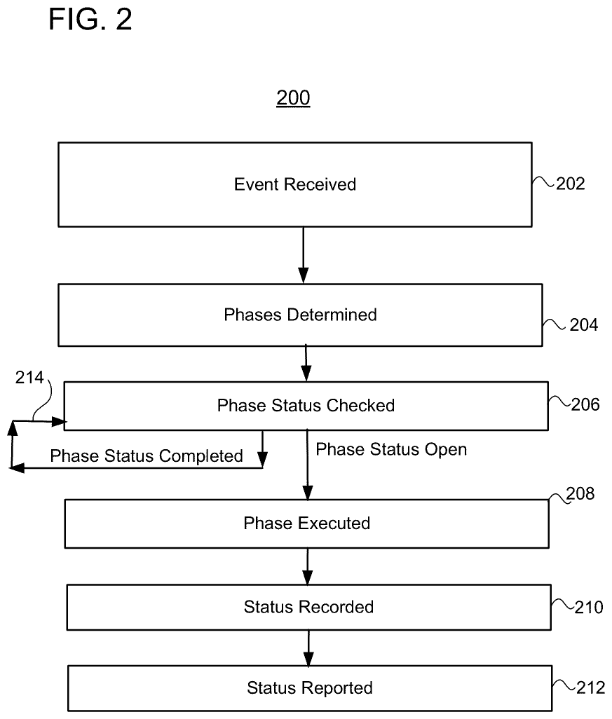

FIG. 2 is a flow diagram of a method 200 according to an embodiment. At 202, an event is received.

At 204, in response to the event, a number of phases of an operation is determined. At 206, a status of a phase is checked.

If the status of the phase is not completed, then at 208 the controller executes the phase of the operation, and at 210 records the status in a non-transitory computer readable storage medium. The status may then be reported 212.

If the status of the phase is determined to have been completed, then the controller iterates 214 to the next phase of the operation.

Further details regarding the implementation of cloud execution according to various embodiments, are now provided in connection with the following example. This example utilizes the HanaCloud database system available from SAP SE of Walldorf, Germany.

### EXAMPLE

The HanaCloud database system runs utilizing a KUBERNETES based eventing framework. This particular example illustrates cloud execution of a recovery operation according to one embodiment.

In KUBERNETES, the controller pattern is widely used. The controller pattern defines that a program is executed once there exist events for a specific file/resource type. In KUBERNETES, the controller seeks to bring a controlled resource (e.g. a database) closer to the state which is defined in a resource/file.

Accordingly, embodiments can adapt this controller pattern in order to make use of a resource/file which holds the information for a one time operation (instead of a desired state). In particular, a controller is created to interact with those resource(s) and to reports states in the corresponding resource(s).

The controller is triggered when a new resource is created or an already existing resource is updated. Thus a customer or a program interacting with the controller, can create such a resource holding the information for the one time (e.g., recovery) operation, and then populate that controller.

Once the resource is created, the controller is executed. The controller can be designed to run in different phases. For each phase, the controller checks if the execution of the phase is needed, ending with reporting the state back into the resource holding the information.

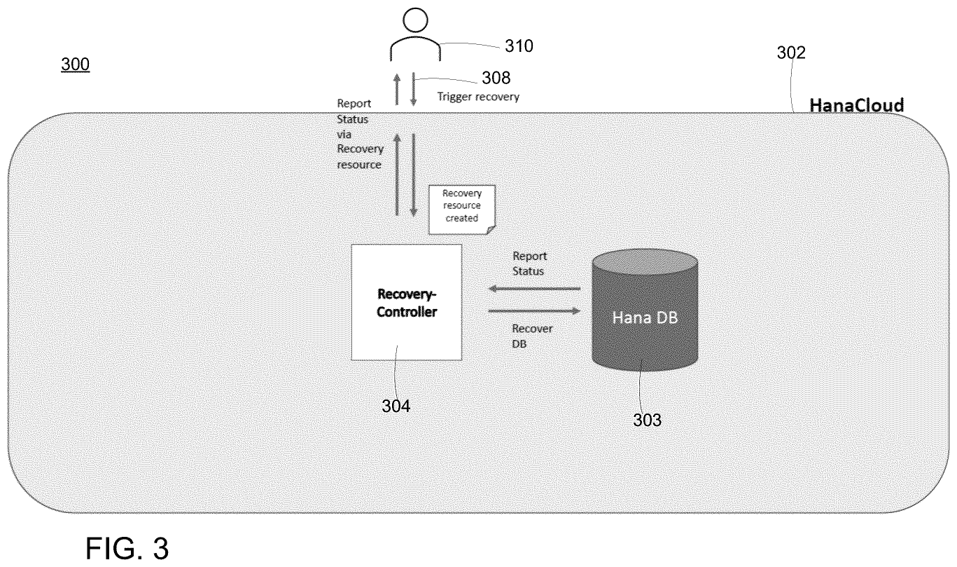

This particular illustrative example involves a data recovery operation being performed in HanaCloud. FIG. 3 shows an overview of an environment 300 including the HanaCloud system 302. In particular, the HanaCloud comprises a Hana database (DB) 303 available from SAP SE of Walldorf, Germany.

The recovery controller 304 is in communication with the Hana DB 306. The recovery controller is configured to initiate a recovery operation triggered by an input 308 received from a user 310.

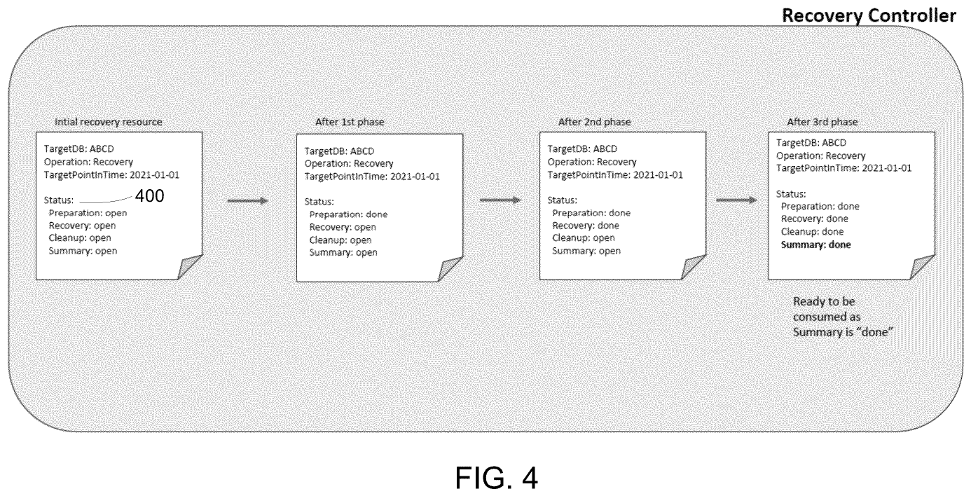

In this example, the HanaCloud controller is designed to run in a loop which is distributed in the following three distinct phases for a recovery operation:
1) preparation,
2) recovery, and
3) cleanup.
   FIG. 4 shows these different phases in the recovery controller.

Every phase begins with a check to see if the execution of the phase is needed, or whether that phase has already been executed. This decision can be determined from the status field 400 of the resource.

Phases end with a report of the state back into the status field of the resource which is stored in the non-transitory computer readable storage medium.

Owing to the resource-based and event-based design of this exemplary embodiment, synchronous calls are not needed. The program can be scaled to provide multiple recoveries concurrently.

Using this pattern, issues such as:
faulty connections,
node replacement, or
a sudden shutdown of the program,
   can arise, but reports of incorrect status to the customer, or recoveries that are not fully executed, can be avoided.

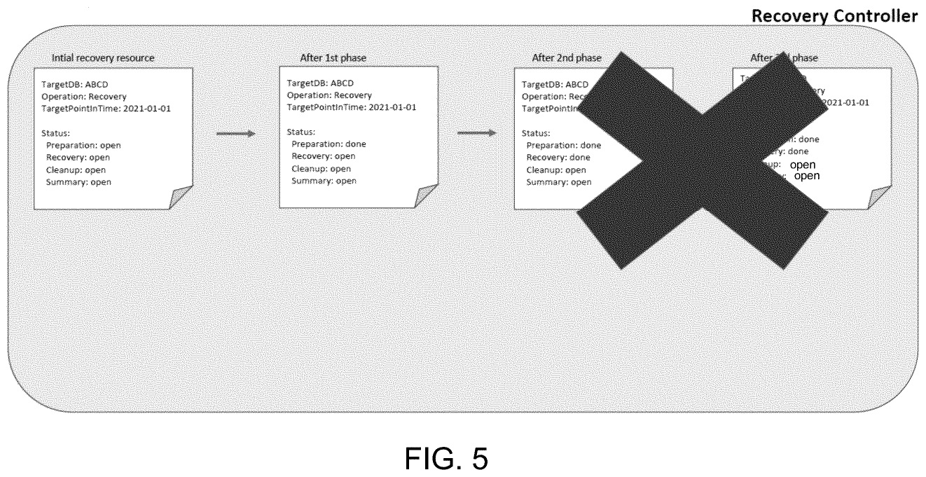

Rather, the program can pick up a task where it was interrupted. For example, FIG. 5 shows an error occurring after completion of the second (recovery) phase but prior to completion of the third (cleanup) phase of a recovery operation.

As a result of this error, the recovery controller was restarted during execution of a phase. After restarting, the recovery controller:
receives the resource to work on (“TargetDB=ABCD”),
checks that phase 1 was already done based on its status (“done”),
checks that phase 2 was already done based its status (“done”),
checks that phase 3 has not been completed due to its status (“open”).

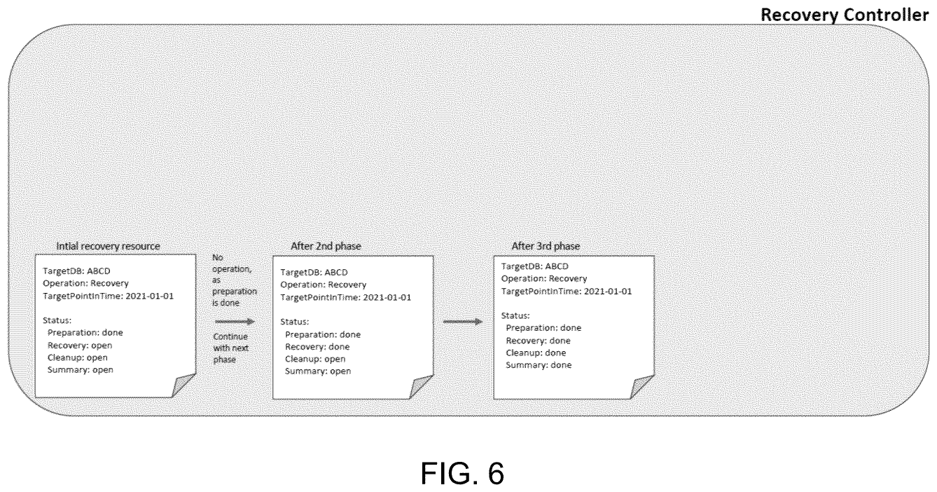

Then, the recovery controller can efficiently orchestrate execution of just the remaining phase 3 in order to complete the recovery operation. This is shown in FIG. 6.

Embodiments may offer one or more benefits. One possible benefit is simplicity. Specifically, only a single controller is needed. The complexity of passing of information via multiple components—e.g., separate/distinct (HanaService/job/backup) services—is avoided. This can lead to faster processing times and fewer unexpected errors.

Embodiments may also offer the benefit of resilience. That is, embodiments may be failsafe due to the unique status reporting and verification. This can render the controller immune to interferences (e.g., node replacement; connection abort). In the event an attempted interference occurs, the controller will pick up at the phase that it was halted.

Embodiments may be easily implemented and transparent to trigger operations. That is, embodiments create a single file/resource holding the information that is needed.

Embodiments may be transparent to report status back to a consuming program/customer. Following the one time operation, a file/resource is created and only the status field of that file/resource can be watched and reported.

Another possible benefit derives from the cloud execution being event driven. For example, the KUBERNETES system can be used to notify other components based upon an event once the file/resource processed by the controller is successfully updated.

Still another possible benefit is based upon the deterministic behavior exhibited by embodiments. Once an operation is terminated with success/error, a consuming program can delete the file/resource after it reported the status to the customer or another program. This results in efficient consumption of memory resources, as little residual information remains in the environment for storage.

Still another possible benefit offered by embodiments, is scalability. That is, a controller can handle 1−n resources in parallel (depending on the available memory and compute power).

Returning now to FIG. 1, there the particular embodiment is depicted with the controller as being located outside of the database. However, this is not required.

Rather, alternative embodiments could leverage the processing power of an in-memory database engine (e.g., the in-memory database engine of the HANA in-memory database available from SAP SE), in order to perform various functions as described above.

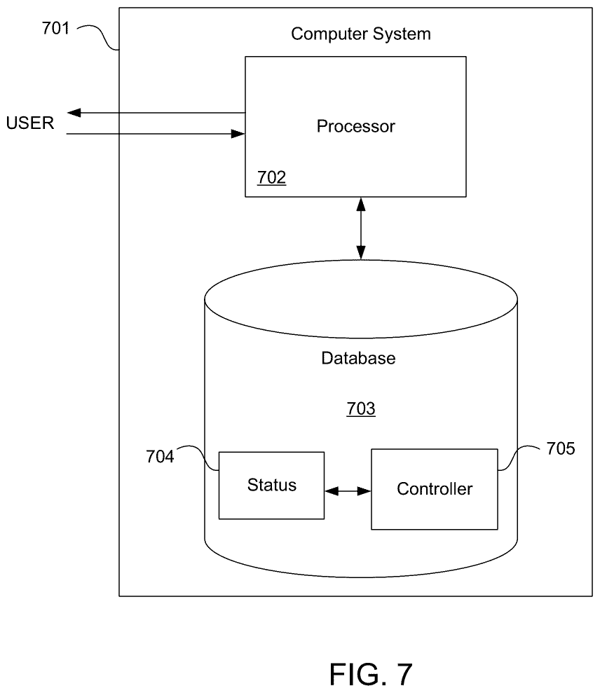

Thus FIG. 7 illustrates hardware of a special purpose computing machine configured to implement cloud operations according to an embodiment. In particular, computer system 701 comprises a processor 702 that is in electronic communication with a non-transitory computer-readable storage medium comprising a database 703. This computer-readable storage medium has stored thereon code 705 corresponding to a controller. Code 704 corresponds to a status. Code may be configured to reference data stored in a database of a non-transitory computer-readable storage medium, for example as may be present locally or in a remote database server. Software servers together may form a cluster or logical network of computer systems programmed with software programs that communicate with each other and work together in order to process requests.

In view of the above-described implementations of subject matter this application discloses the following list of examples, wherein one feature of an example in isolation or more than one feature of said example taken in combination and, optionally, in combination with one or more features of one or more further examples are further examples also falling within the disclosure of this application:

Example 1. Computer implemented system and methods comprising:
a controller receiving an event from an eventing framework;
in response to the event, the controller determining phases of a cloud operation;
the controller checking a status of each phase of the cloud operation;
if the status is open, the controller:
executing the phase of the cloud operation,
recording a completed status in a non-transitory computer readable storage medium, and reporting the completed status; and
if the status is completed, the controller:
iterating to a check a status of a next phase of the cloud operation.

Example 2. The computer implemented system and method of Example 1 wherein the eventing framework is external to the controller.

Example 3. The computer implemented system and method of Example 1 or 2 wherein the eventing framework is KUBERNETES.

Example 4. The computer implemented system and method of Example 1 wherein the eventing framework is internal to the controller.

Example 5. The computer implemented system and method of Example 1 or 4 wherein the event is received in response to polling.

Example 6. The computer implemented system and method of Example 1, 4, or 5 further comprising:
prior to receiving the event, the controller configuring a polling frequency.

Example 7. The computer implemented system and method of Examples 1, 2, 3, 4, 5, or 6 further comprising:
prior to receiving the event, the controller configuring the eventing framework to communicate the event to the controller.

Example 8. The computer implemented system and method of Examples 1, 2, 3, 4, 5, 6, or 7 wherein the status is open due to a communications failure.

Example 9. The computer implemented system and method of Examples 1, 2, 3, 4, 5, 6, 7, or 8 further comprising:
deleting the status from the non-transitory computer readable storage medium after success or failure of the operation.

Example 10. The computer implemented system and method of Examples 1, 2, 3, 4, 5, 6, 7, 8, or 9 wherein:
the non-transitory computer readable storage medium comprises an in-memory database; and
an in-memory database engine of the in-memory database records the status in the in-memory database.

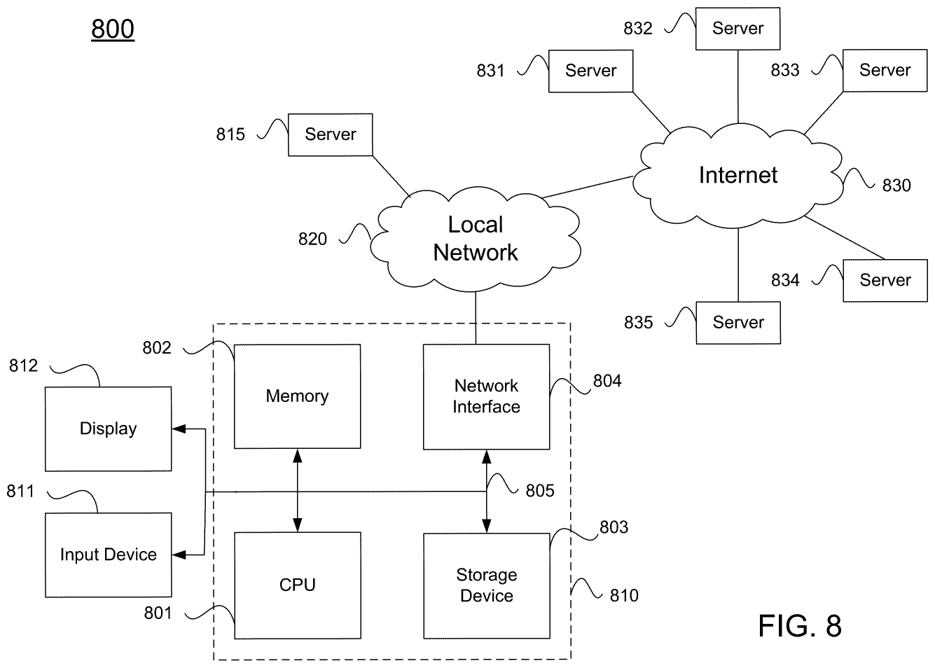

An example computer system 800 is illustrated in FIG. 8. Computer system 810 includes a bus 805 or other communication mechanism for communicating information, and a processor 801 coupled with bus 805 for processing information. Computer system 810 also includes a memory 802 coupled to bus 805 for storing information and instructions to be executed by processor 801, including information and instructions for performing the techniques described above, for example. This memory may also be used for storing variables or other intermediate information during execution of instructions to be executed by processor 801. Possible implementations of this memory may be, but are not limited to, random access memory (RAM), read only memory (ROM), or both. A storage device 803 is also provided for storing information and instructions. Common forms of storage devices include, for example, a hard drive, a magnetic disk, an optical disk, a CD-ROM, a DVD, a flash memory, a USB memory card, or any other medium from which a computer can read. Storage device 803 may include source code, binary code, or software files for performing the techniques above, for example. Storage device and memory are both examples of computer readable mediums.

Computer system 810 may be coupled via bus 805 to a display 812, such as a Light Emitting Diode (LED) or liquid crystal display (LCD), for displaying information to a computer user. An input device 811 such as a keyboard and/or mouse is coupled to bus 805 for communicating information and command selections from the user to processor 801. The combination of these components allows the user to communicate with the system. In some systems, bus 805 may be divided into multiple specialized buses.

Computer system 810 also includes a network interface 804 coupled with bus 805. Network interface 804 may provide two-way data communication between computer system 810 and the local network 820. The network interface 804 may be a digital subscriber line (DSL) or a modem to provide data communication connection over a telephone line, for example. Another example of the network interface is a local area network (LAN) card to provide a data communication connection to a compatible LAN. Wireless links are another example. In any such implementation, network interface 804 sends and receives electrical, electromagnetic, or optical signals that carry digital data streams representing various types of information.

Computer system 810 can send and receive information, including messages or other interface actions, through the network interface 804 across a local network 820, an Intranet, or the Internet 830. For a local network, computer system 810 may communicate with a plurality of other computer machines, such as server 815. Accordingly, computer system 810 and server computer systems represented by server 815 may form a cloud computing network, which may be programmed with processes described herein. In the Internet example, software components or services may reside on multiple different computer systems 810 or servers 831-835 across the network. The processes described above may be implemented on one or more servers, for example. A server 831 may transmit actions or messages from one component, through Internet 830, local network 820, and network interface 804 to a component on computer system 810. The software components and processes described above may be implemented on any computer system and send and/or receive information across a network, for example.

The above description illustrates various embodiments of the present invention along with examples of how aspects of the present invention may be implemented. The above examples and embodiments should not be deemed to be the only embodiments, and are presented to illustrate the flexibility and advantages of the present invention as defined by the following claims. Based on the above disclosure and the following claims, other arrangements, embodiments, implementations and equivalents will be evident to those skilled in the art and may be employed without departing from the spirit and scope of the invention as defined by the claims.

1. A method of recovering from an error in a cloud database comprising:
a controller, in communication with the cloud database, receiving an event from an eventing framework, the event initiating a cloud database recovery operation for the cloud database;
in response to the event, the controller executing the cloud database recovery operation, the cloud database recovery operation comprising a preparation phase, a recovery phase, and a cleanup phase, wherein each phase is associated with a status, and wherein each phase begins with a check to determine, based on an associated status of a particular phase, whether or not execution of the particular phase is needed and ends with storing the associated status of the particular phase in a non-transitory computer readable medium, and wherein, when the error occurs during one of the preparation phase, the recovery phase, or the cleanup phase, the controller is restarted;
the controller sequentially checking the associated status of each phase of the cloud database recovery operation stored in the non-transitory computer readable medium;
if the associated status is open, the controller:
executing the phase of the cloud database recovery operation,
recording a completed status in the non-transitory computer readable storage medium, and
reporting the completed status; and
if the status is completed, the controller:
iterating to check the associated status of a next phase of the cloud database recovery operation.

2. A method as in claim 1 wherein the eventing framework is external to the controller.

3. A method as in claim 2 wherein the eventing framework is KUBERNETES.

4. A method as in claim 1 wherein the eventing framework is internal to the controller.

5. A method as in claim 4 wherein the event is received in response to polling.

6. A method as in claim 5 further comprising:
prior to receiving the event, the controller configuring a polling frequency.

7. A method as in claim 1 further comprising:
prior to receiving the event, the controller configuring the eventing framework to communicate the event to the controller.

8. A method as in claim 1 wherein the status is open due to a communications failure.

9. A method as in claim 1 further comprising deleting the status from the non-transitory computer readable storage medium after success or failure of the operation.

10. A method as in claim 1 wherein:
the non-transitory computer readable storage medium comprises an in-memory database; and
an in-memory database engine of the in-memory database records the status in the in-memory database.

11. A non-transitory computer readable storage medium embodying a computer program for performing a method of recovering from an error in a cloud database, said method comprising:
a controller, in communication with the cloud database, receiving an event from a KUBERNETES eventing framework, the event initiating a cloud database recovery operation for the cloud database;
in response to the event, the controller executing the cloud database recovery operation, the cloud database recovery operation comprising a preparation phase, a recovery phase, and a cleanup phase, wherein each phase is associated with a status, and wherein each phase begins with a check to determine, based on an associated status of a particular phase, whether or not execution of the particular phase is needed and ends with storing the associated status of the particular phase in a non-transitory computer readable medium, and wherein, when the error occurs during one of the preparation phase, the recovery phase, or the cleanup phase, the controller is restarted;
the controller sequentially checking the associated status of each phase of the cloud database recovery operation stored in the non-transitory computer readable medium;
if the associated status is open, the controller:
executing the phase of the cloud database recovery operation,
recording a completed status in the non-transitory computer readable storage medium, and
reporting the completed status; and
if the status is completed, the controller:
iterating to check the associated status of a next phase of the cloud database recovery operation.

12. A non-transitory computer readable storage medium as in claim 11 wherein the method further comprises:
prior to receiving the event, the controller configuring the KUBERNETES eventing framework to communicate the event to the controller.

13. A non-transitory computer readable storage medium as in claim 11 wherein the method further comprises:
deleting the status from the non-transitory computer readable storage medium after success or failure of the operation.

14. A non-transitory computer readable storage medium as in claim 11 wherein the status is open due to a communications failure.

15. A computer system configured to recover from an error in a cloud database, the computer system comprising:
one or more processors;
a software program, executable on said computer system, the software program configured to cause an in-memory database engine of an in-memory database to:
receive an event from an eventing framework, the event initiating the cloud database recovery operation for the cloud database;
in response to the event, executing, by a controller, the cloud database recovery operation, the cloud database recovery operation comprising a preparation phase, a recovery phase, and a cleanup phase, wherein each phase is associated with a status, and wherein each phase begins with a check to determine, based on an associated status of a particular phase, whether or not execution of the particular phase is needed and ends with storing the associated status of the particular phase in a non-transitory computer readable medium, and wherein, when the error occurs during one of the preparation phase, the recovery phase, or the cleanup phase, the controller is restarted;
sequentially check the associated status of each phase of the cloud database recovery operation stored in the non-transitory computer readable medium;
if the associated status is open:
execute the phase of the cloud database recovery operation,
record a completed status in the in-memory database, and
report the completed status; and
if the status is completed:
iterate to check the associated status of a next phase of the cloud database recovery operation.

16. A computer system as in claim 15 wherein the eventing framework is external to the in-memory database.

17. A computer system as in claim 16 wherein the evening framework is KUBERNETES.

18. A computer system as in claim 15 wherein the evening framework is internal to the in-memory database.

19. A computer system as in claim 18 wherein the event is received in response to polling.

20. A computer system as in claim 15 wherein the in-memory database engine is further configured to delete the status from the in-memory database after success or failure of the operation.
